(19) United States
(12) Patent Application Publication
(10) Pub. No.: US 2025/0003475 A1
(43) Pub. Date: Jan. 2, 2025

(54) FACE TOOTHING WITH SHAPING RADII

(71) Applicant: Schaeffler Technologies AG & Co. KG, Herzogenaurach (DE)

(72) Inventors: Andreas Kaiser, Werneck (DE); Daniel Koenig, Grafenrheinfeld (DE); Simon Braehler, Petersberg (DE); Norbert Gross, Werneck (DE)

(73) Assignee: Schaeffler Technologies AG & Co. KG, Herzogenaurach (DE)

(21) Appl. No.: 18/697,845

(22) PCT Filed: Sep. 12, 2022
(86) PCT No.: PCT/DE2022/100671

§ 371 Date: Apr. 2, 2024

(30) Foreign Application Priority Data
Oct. 11, 2021 (DE) 10 2021 126 242.9

(51) Int. Cl. F16H 55/17; F16H 55/08

(52) U.S. Cl. CPC F16H 55/17; F16H 55/08; F16H 2055/173

(57) ABSTRACT

A spur toothing includes a plurality of radially extending teeth arranged on an end face, circumferentially adjacent to one another, and arranged to mesh with a mating toothing. Each tooth of the plurality of radially extending teeth has tooth flanks, a tooth tip, and a radially outer tooth profile face. A transition from the tooth flanks to the radially outer tooth profile face has a shaping radii. A tool for producing the spur toothing is also disclosed.

### CROSS-REFERENCE TO RELATED APPLICATIONS

This application is the United States National Phase of PCT Appln. No. PCT/DE2022/100671 filed Sep. 12, 2022, which claims priority to German Application No. DE102021126242.9 filed Oct. 11, 2021, the entire disclosures of which are incorporated by reference herein.

### TECHNICAL FIELD

The present disclosure relates to a spur toothing, a use of such a spur toothing in a wheel bearing arrangement, a tool for producing a spur toothing and a use of such a tool for producing a spur toothing on a wheel bearing hub.

### BACKGROUND

The use of spur toothings as an axially effective coupling of rotating elements, such as shafts, is well known. In particular, spur toothings are known which form a sprocket extending in the circumferential direction about a rotation axis on a wheel bearing arrangement for a drivable wheel hub, wherein the spur toothing is provided for backlash-free engagement in a mating toothing facing the spur toothing.

Among other things, spur toothings can be produced by machining or by a forming process. The assembly of spur toothings, in particular the engagement of two spur toothings with one another, can be made more difficult by the known production processes.

### SUMMARY

The spur toothing according to the disclosure, e.g., for a wheel bearing arrangement driven wheels, has multiple teeth which are arranged on the end face and adjacent to one another in the circumferential direction and extend in the radial direction. The teeth may be designed to mesh axially, i.e., in the axial direction, with the teeth of a mating toothing. Each of the teeth has at least tooth flanks and a tooth tip. In this regard, a transition from the tooth flanks to a tooth profile face arranged on the outside in the radial direction has rounding radii or shaping radii.

The term “tooth profile face” is understood to mean a cross-sectional area of the tooth that is formed with a section in the circumferential direction. The tooth profile face arranged on the outside in the radial direction is to be understood as the outer surface of a tooth formed in the radial direction on the outside, e.g., along an outer circumference of the spur toothing.

The rounding radii, which can also be referred to as shaping radii, reduce, e.g., avoid, a sharp-edged and/or burr-like transition between the tooth profile face arranged radially on the outside and the tooth flanks. This can reduce the risk of injury, e.g., when assembling the wheel bearing arrangement. In addition, an unwanted detachment of particles, e.g., from the burr formed, can be reduced, e.g., during the period of use. Furthermore, the production process can be improved by using such a spur toothing. For example, the formation of a tooth tip can be improved by limiting the flow of material in the radial direction to the outside during production and guiding it through the shaping radii in such a way that a raising of the tooth tip can be achieved. Raising the tooth tip allows for a “more pointed” tooth tip, i.e., a small tooth tip radius. The smaller the tooth tip radius, the more pointed the tooth tip. This makes it possible to avoid an undesirable tooth-on-tooth position during assembly.

The spur toothing may be used for wheel bearing arrangements with driven wheel bearings, e.g., for coupling a wheel bearing to a drive shaft or an axle journal.

The axial direction and the radial direction are to be understood in relation to the end face. This means that the axial direction extends along a central or rotation axis of the end face and the radial direction extends along a radius of the essentially circular segment-like, e.g., ring-like, or circular ring-like, end face.

According to one embodiment, the shaping radii and the tooth profile face transition tangentially into one another and/or the shaping radii and the tooth flanks transition tangentially into one another. A tangential transition helps to reduce sharp-edged and/or burred edges or transitions and can thus reduce the risk of injury, e.g., during assembly. In addition, the tangential transition can improve the flow of material in the direction of the tooth tip during the production of the spur toothing.

According to one embodiment, the tooth profile faces arranged on the outside in the radial direction essentially have an inclination in the axial direction of between 0° and 25°. An improved tooth tip formation can be achieved in this manner.

According to one embodiment, the tooth profile faces arranged on the outside in the radial direction each have a main shaping radius extending in the radial direction. The main shaping radius can improve the flow of material towards the tooth tip during production.

According to one embodiment, the tooth tip has a tooth tip radius of between about 0.5 mm and about 5 mm, e.g., between 0.7 mm and 3 mm. Such a tooth tip radius can reduce the risk of a tooth-on-tooth position occurring during assembly and thus simplify the assembly. In this regard, the tooth tip radius can be a single radius or can be made up of multiple individual radii that transition tangentially into one another.

A further aspect of the disclosure relates to a use of at least one spur toothing of a wheel bearing arrangement according to the disclosure for the non-rotatable connection of a wheel bearing hub to an axle journal. Spur toothings in wheel bearing arrangements are exposed to high loads, for example. On the one hand, the spur toothing described above and below allows for an improved engagement with a corresponding mating toothing and thus improved force transmission, which allows for a higher load on this connection.

A further aspect of the disclosure relates to a tool for producing a spur toothing, e.g., a spur toothing according to the disclosure. The tool has a mating toothing that has multiple teeth which are arranged on the end face and adjacent to one another in the circumferential direction and extend in the radial direction. Two mutually adjacent teeth are arranged spaced from one another by a tooth gap in each case. In this regard, a transition from the tooth flanks of the tooth gaps to a tooth profile face arranged on the outside in the radial direction has shaping radii and a circumferential tool edge which surrounds the mating toothing, e.g., on the outside in the radial direction.

During production of the spur toothing, the circumferential tool edge reduces or limits the flow of material in the radially outward direction. This increases the resistance for the flowing material in the radial direction. As the material always flows in the direction of least resistance, the flow of material deviates to the circumferential and/or vertical direction (axial direction). The shaping radii additionally facilitate the flow of material in the circumferential and/or vertical direction. In this way, the degree of filling of the tooth mold formed by the tooth gaps of the tool can be improved, e.g., in the direction of the tooth tip, whereby the formation of a more pointed tooth can be achieved. This reduces the risk of tooth-on-tooth positioning during assembly.

According to one embodiment, the tool edge extends at least to a depth of a tooth base formation of the tooth gaps.

This prevents a collision with a radially longer mating toothing during assembly. For example, in the case of spur toothings on a wheel bearing hub, the tool edge on the toothing of the wheel bearing extends at least to the depth of the tooth base formation.

A further aspect of the disclosure relates to a use of a tool according to the disclosure for producing a spur toothing, e.g., a spur toothing described above and below, on a wheel bearing hub by means of orbital riveting.

In orbital riveting, for example, the material flows according to the law of least resistance, which is generally lowest in the radially outward direction and higher in the vertical direction, i.e., in the axial direction with respect to the tooth mold narrowing towards the tooth tip. The radially outer circumferential tool edge of the tool described above and below increases the resistance in the radial direction, e.g., in the radially outward direction, in such a way that the material deviates to the circumferential and/or vertical direction of the toothing. The shaping radii additionally favor such a flow of material, as they facilitate the flow of material in this direction.

In other words, it can be said that the radially outer circumferential tool edge increases the resistance for the flow of material in the radially outward direction in such a way that the material, which flows according to the law of least resistance, flows in the circumferential and/or vertical direction of the toothing, as this now represents the lower resistance. The shaping radii can additionally favor the flow of material in the circumferential and/or vertical direction, as the rounded edges due to the shaping radii additionally facilitate the flow of material.

### BRIEF DESCRIPTION OF THE DRAWINGS

Further measures to improve the disclosure are shown in more detail below together with the description of an exemplary embodiment based on the figures. In the figures:

FIG. 1 shows a schematic representation of a spur toothing according to an embodiment of the disclosure in a top view;

FIG. 2 shows an enlarged partial section of the spur toothing from FIG. 1;

FIG. 3 shows a schematic representation of a partial view of a spur toothing according to an embodiment of the disclosure in a perspective view; and

FIG. 4 shows a schematic representation of a tool according to an embodiment of the disclosure in a perspective view.

### DETAILED DESCRIPTION

The figures are only schematic in nature, not to scale and serve only for understanding of the disclosure. The same elements are marked with the same reference symbols.

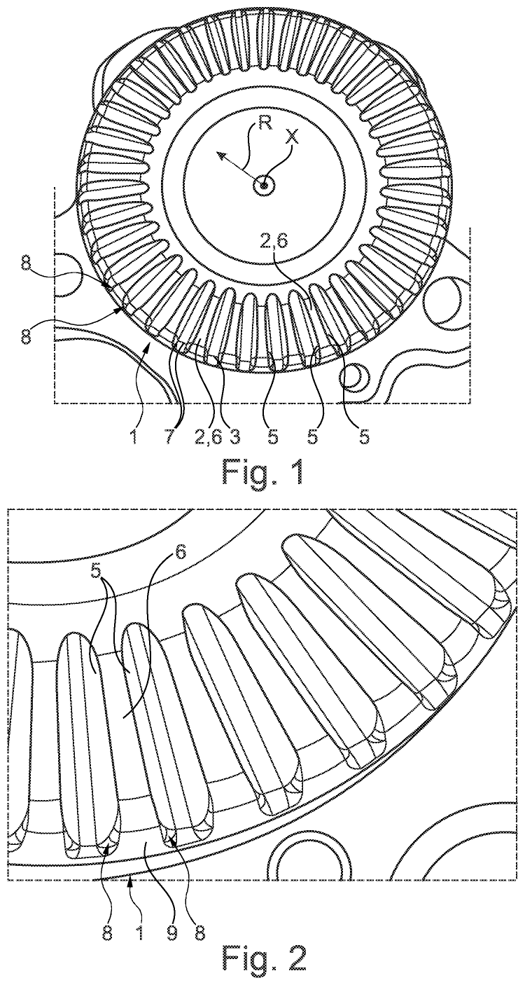

FIGS. 1 and 2 show an exemplary schematic representation of a spur toothing 1, wherein FIG. 2 shows an enlarged section of the spur toothing 1 from FIG. 1. The spur toothing 1 has multiple teeth 2 which are arranged spaced from one another in the circumferential direction by tooth gaps 3 on a surface, for example an end face of a shaft. In this regard, a tooth profile corresponds to a cross-sectional area in the axial direction, in this case the direction of a rotation axis X, of the end face. In other words, the cross-sectional area can be said to correspond to a sectional area of a section in the circumferential direction. An extension direction of the teeth 2 corresponds to a radial direction R of the end face.

Each of the teeth 2 has tooth flanks 5, a tooth tip 6 and tooth bases. The tooth flanks 5 are formed on the side surfaces of the tooth 2 and transition essentially tangentially into the tooth tip 6 and the tooth bases. The tooth tip 6 is arranged essentially in the center and forms the “peak” of the tooth 2, which comprises the highest point of the tooth 2 when viewed in the axial direction.

The spur toothing 1 can also be referred to as a Hirth toothing and is an axially effective toothing that can be used as a form-fitting coupling of rotating elements, for example to couple driven wheel bearings to the drive shaft, for torque transmission. For this purpose, the spur toothing 1 meshes in the axial direction with a correspondingly designed mating toothing (not shown). In such a connection, the flanks 5 of the teeth 2 are in static and flat contact with the flanks of the teeth of the mating toothing.

The teeth of the spur toothing 1 have radially outer shaping radii 8, which round off a transition between a radially outer tooth profile face 9 and the tooth flanks 5. The shaping radii 8 reduce or prevent sharp-edged and/or burred transitions, which pose a potential risk of injury during assembly. This can also prevent particles that are undesirable in the production environment from becoming detached during operation.

In addition, the shaping radii 8, which can also be referred to as rounding radii, allow the ratio of the flow resistance between the axial direction and the radial direction to be changed such that the flow resistance in the radial direction is increased such that the flow resistance in the axial direction is equal to or less than the flow resistance in the radial direction. This allows the material to flow during production in such a way that a more pointed tooth tip 6 can be formed. The more pointed the tooth tip 6, the lower the risk of a tooth-on-tooth position when assembling the spur toothing 1 with a corresponding mating toothing.

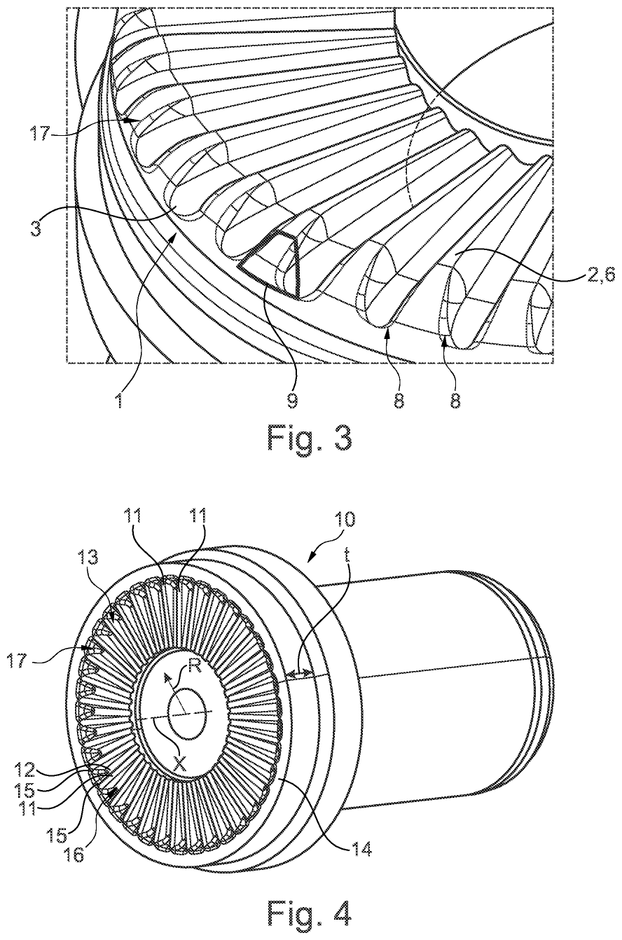

FIG. 3 shows that the tooth profile face 9 has higher tooth flanks 5 due to the formation of a more pointed tooth tip 6, which allows for greater power transmission. In addition, it can be seen that the tooth profile face 9 has an inclination of approximately 50 to 10° with respect to the axial direction. Alternatively, the tooth profile face 9 can also have an inclination of essentially 0° and/or up to 25°. In addition, the tooth profile face 9 has a main shaping radius 17 (see FIG. 4), which extends in the radial direction. As a result, the tooth profile face 9 has a rounding, in particular a convex rounding, which protrudes in the radial direction.

FIG. 4 shows an exemplary schematic representation of a tool 10 in a perspective view. The tool 10 is used to produce the spur toothing 1 by means of orbital riveting. It can be seen that the tool 10 also has multiple teeth 11, which are arranged spaced from one another in the circumferential direction by tooth gaps 12 on an end face of the tool 10. The teeth 11 and the tooth gaps 12 in their entirety can also be referred to as the toothing 13 of the tool 10.

The tooth gaps 12 of the tool 10 serve as a mold for forming the teeth 2 of the spur toothing 1. Radially on the outside, the tool 10 has a tool edge 14 that surrounds the toothing 13 radially on the outside in the circumferential direction. The tool edge 14 has a depth t in the axial direction, which extends to a tooth base formation. In this regard, the tooth base formation describes a boundary in the tooth gaps 12 of the tool 10, which serve to form the tooth bases of the teeth 2 of the spur toothing 1.

The tool edge 14 completely closes the tool 10 in the radial direction along the circumferential direction and thus limits the flow of material in the radial direction during the production of the spur toothing 1. The tool edge 14 thus represents a large resistance for the material flowing during production. Since the flow of material follows the law of least resistance, the material flows in the circumferential direction and/or the vertical direction of the respective tooth gap 12 after it has come into contact with the tool edge 14 radially on the outside, whereby a tooth 2 of the spur toothing 1 is formed in each tooth gap 12. Shaping radii 15 formed in the tooth gaps 12 are designed in such a way that the shaping radii 8, which form the transition between the tooth profile face 9 and the tooth flanks 5, are formed during production.

For example, the shaping radii 15 may have such a radius that resistance to the flow of material during production is reduced and the material thus flows—according to the law of least resistance—in the circumferential direction into the shaping radii 12 of the tool 10. As a result, a flow of material in the direction of a tooth tip mold 16 can be improved, e.g., by way of a correspondingly high force with which the tool 10 is pressed or rolled onto the material to be shaped during the production of the spur toothing 1. This makes it possible to improve the tooth tip formation during production.

This means that the tooth tip 6 of the spur toothing 1, as already described above, is more pointed, as the material flows further into the tooth tip mold 16 of the tooth gap 12 of the tool 10. This can reduce the risk of tooth-on-tooth positioning during assembly of the spur toothing 1 with a corresponding mating toothing. In addition, the teeth 2 have larger or higher tooth flanks 5, which allow for improved power transmission in operation when meshing with a corresponding mating toothing (not shown).

### REFERENCE NUMERALS

1 Spur toothing
2 Tooth
3 Tooth gap
5 Tooth flank
6 Tooth tip
8 Shaping radius
9 Tooth profile face
10 Tool
11 Tooth
12 Tooth gap
13 Toothing
14 Tool edge
15 Shaping radius
16 Tooth tip mold
17 Main shaping radius
X Rotation axis
R Radial direction
t Depth

1. A spur toothing for a wheel bearing arrangement, having:
multiple teeth which are arranged on an end face and adjacent to one another in a circumferential direction, extend in a radial direction (R) and are designed to mesh axially with teeth of a mating toothing,
wherein each of the teeth has tooth flanks and a tooth tip, wherein a transition from the tooth flanks to a tooth profile face arranged on an outside in the radial direction (R) has shaping radii.

2. The spur toothing according to claim 1, wherein:
the shaping radii and the tooth profile face transition tangentially into one another; or
the shaping radii and the tooth flanks transition tangentially into one another.

3. The spur toothing according to claim 1, wherein the tooth profile faces arranged on the outside in the radial direction (R) comprise an inclination in an axial direction (X) of between 0° and 25°.

4. The spur toothing according to claim 1, wherein the tooth profile faces arranged on the outside in the radial direction (R) each have a main shaping radius extending in the radial direction (R).

5. The spur toothing according to claim 1, wherein the tooth tip has a tooth tip radius which is between about 0.5 mm and about 5 mm.

6. (canceled)

7. A tool for producing a spur toothing, having:
a mating toothing having multiple teeth which are arranged on an end face and adjacent to one another in a circumferential direction and extend in a radial direction (R),
wherein in each case two mutually adjacent teeth are spaced from one another by a tooth gap, wherein a transition from tooth flanks of the tooth gaps to a tooth profile face arranged on an outside in the radial direction (R) has shaping radii and a circumferential tool edge which surrounds the mating toothing.

8. The tool according to claim 7, wherein the tool edge extends at least to a depth (t) of a tooth base formation of the tooth gaps.

9. (canceled)

10. A spur toothing comprising:
a plurality of radially extending teeth:
arranged on an end face;
circumferentially adjacent to one another; and
arranged to mesh with a mating toothing, wherein:
each tooth of the plurality of radially extending teeth comprises:
tooth flanks;
a tooth tip; and
a radially outer tooth profile face; and
a transition from the tooth flanks to the radially outer tooth profile face comprises a shaping radii.

11. The spur toothing of claim 10, wherein:
the shaping radii and the radially outer tooth profile face transition tangentially into one another; or
the shaping radii and the tooth flanks transition tangentially into one another.

12. The spur toothing of claim 10, wherein the radially outer tooth profile face is axially inclined at an angle between 0° and 25°.

13. The spur toothing of claim 10, wherein the radially outer tooth profile face comprises a radially extending main shaping radius.

14. The spur toothing of claim 10, wherein the tooth tip comprises a tooth tip radius between 0.5 mm and 5 mm.
